(19) United States
(12) Patent Application Publication
(10) Pub. No.: US 2024/0257109 A1
(43) Pub. Date: Aug. 1, 2024

(54) METHOD FOR BARTERING SILVER AND GOLD FOR GROCERIES

(71) Applicant: Gregory John Wenkman, Travelers Rest, SC (US)

(72) Inventor: Gregory John Wenkman, Travelers Rest, SC (US)

(21) Appl. No.: 18/102,748

(22) Filed: Jan. 29, 2023

(51) Int. Cl. G06Q 20/38; G06Q 20/20; G06Q 20/32; G06Q 20/34

(52) U.S. Cl. CPC G06Q 20/381; G06Q 20/20; G06Q 20/325; G06Q 20/34

(57) ABSTRACT

A method for transacting barter between: (a) an individual possessing and owning coins, tokens, bars, or bills, made of silver or gold to barter for groceries at a retailer or wholesaler that sells groceries, and (b) a retailer or wholesaler who sells groceries and who barters groceries with an individual for his or her coins, tokens, bars, or bills, made of silver or gold, with an intermediate step of using a Bartered Value Card (BVC).

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### FIELD OF THE INVENTION

The present invention relates generally to a method of transacting barter and or barter transaction and more specifically the present invention relates to a method of barter and or barter transaction between an individual possessing and owning coins, tokens, bars, or bills, made of silver or gold to barter for food or other groceries and goods at a retailer or wholesaler that sells groceries and other goods and a retailer or wholesaler that sells groceries and other goods that is looking to barter food or other groceries and goods with an individual possessing and owning coins, tokens, bars, and bills, made of silver or gold, and even more particularly the present invention relates to a barter transaction using an intermediate step during the barter transaction where the retailer or wholesaler, and or its authorized employee(s) or authorized agent(s), issues to the individual a Bartered Value Card (BVC), or its equivalent, having been assigned ‘bartered value’, or its equivalent, equal to the agreed to barter value by both parties, where thereafter the BVC having bartered value is exchanged for food or other groceries and goods at the retailer or wholesaler to complete bartered transaction, once the ‘bartered value’ has been depleted.

### BACKGROUND OF THE INVENTION

It is important to understand the background of the present invention which requires an understanding of prior and existing art of barter, money, and currency to understand the importance and timeliness of the present invention.

From the beginning of human civilization, and for thousands of years thereafter, people relied on barter as a means of exchange of goods and services between two parties. This proved to be a very inefficient means of exchange, but there was no other alternative at the time since money had not yet been invented. According to historical record, it wasn't until around 650 B.C. in Lydia, now Turkey, that merchants and consumers started using coins struck of a naturally occurring electrum of gold and silver as a medium of exchange, which at some point became known as money. Coins made of silver and gold came in existence in Asia Minor in the 6th century, and in India in the 5th century, and in China in the late 3rd century, as various historians have determined. Due to the scarce nature of silver and gold in the earth's crust, these precious metals coins or tokens, have stood the test of time to be an excellent ‘store of value’ as money, and therefore are known to have intrinsic value. The cost of exploration, refining, and minting associated with making silver and or gold coins is ‘stored value’ in each coin, forever.

Money is commonly defined, among economists, as a medium that must possess three distinct qualities or elements; money must: (1) be accepted as a means of exchange, (2) be a unit of measure, and (3) be a store of value.

History has shown, all empires begin with money made of gold and silver and end with counterfeit currency.

During the height of the Roman Empire their money and currency were a silver coin called Denarius and a gold coin called Aureus. For some time the value was placed on the Aureus coin as being exchangeable money at the rate of 25 Denarius coins. It is believed that the ratio of silver to gold found in the earth's crust is approximately 17.5 to 1. During this time, Rome flourished as a Republic and their Empire grew over hundreds of years, and many attribute this to their monetary system backed by silver and gold.

The fall of the Roman Empire coincided with the counterfeiting of the silver Denarius and the gold Aureus whereby the Roman government diluted the respective silver and gold content from more than ninety-percent down to where their coins contained little or no silver or gold and were instead made of bronze, using base metals. Once people and merchants realized their goods and services were being exchanged for counterfeit money their monetary-system collapsed, causing the fall of the Roman Empire around 476 A.D. This lead to a period, thereafter, in history called the ‘Dark Ages’, which lasted nearly one-thousand years and where Rome's population fell from approximately one million people to less than 50,000, where people vacated the city for the countryside to survive by growing their own food and where the barter system replaced the failed fiat-currency system.

Over time silver and gold coins, having “stored value”, always made their way back into the monetary-system, only to see future corrupt governments counterfeit their currency, time and again.

Due to the fact that it is impractical, because of weight, for individuals to carry large amounts of silver and gold money on their person; banknotes (made of paper and now cotton and linen) became popular over the last several hundred years, and particularly after the invention of the printing press. Banknotes are a warehouse receipts, issued by banks and are paper promissory notes, known as I.O.U.s, payable to the bearer on demand a certain amount of legal tender, usually silver or gold coin, when presented to the cashier of the originating bank for redemption.

Countless times, over the last several hundred years, upon the bearer's demand for his silver or gold back met with the bank's failure due to fraud and or default by the bank for not having sufficient silver and or gold to cover all the issued and outstanding banknotes.

In 1729, Voltaire stated: “all paper money eventually returns to its intrinsic value—zero”. History has proven Voltaire to be correct. More precisely: all fiat (meaning decreed by law or government and unbacked by a physical commodity such as gold and silver) currency, in history, have gone from being worth less to being worthless over time.

Between 1865 and 1933 gold certificates or banknotes, or Notes were issued in the United States which were I.O.U.s. A gold certificate, in general, is a certificate or Note of ownership by the holder or bearer of the gold certificate is due a specific amount of gold in exchange or redemption for the Note. Between 1878 and 1964 silver certificates were issued in the United States. A silver certificate, in general, is a certificate of ownership of silver by the holder or bearer of the certificate or Note stored by the bank and redeemable by the bearer upon demand. These gold and silvers certificates, or banknotes, or Notes are, once again, nothing more than a paper I.O.U. receipts or Notes between the issuing government or private bank and the bearer of the certificates or Notes.

Banker, J. P. Morgan, stated before Congress in 1912: “Gold is money. Everything else is credit”. Credit is in fact nothing but debt.

The Federal Reserve Act of 1913 was purportedly passed by congress and signed into law by President Woodrow Wilson, thereby allowing the newly created and privately-owned and operated Federal Reserve banking system to usurp control of the United States currency system from the United States Treasury.

In the early years of the Federal Reserve, between 1914 and 1933, issued vast quantities of gold certificates.

Money creation by the Federal Reserve was rampant in the 1920's which lead to what was termed the “roaring '20's”. The Federal Reserve in 1929 reduced the money supply thus causing the stock market collapse of 1929-32, and the subsequent Great Depression, where the Dow Jones stock market fell eighty-nine percent. On Mar. 6, 1933 President Roosevelt issued Proclamation 2039 wherein it stated in the first sentence: “Whereas there have been heavy and unwarranted withdrawals of gold and currency from our banking institutions for the purpose of hoarding . . . has resulted in severe drains on the Nation's stocks of gold . . . ”. In this proclamation it ordered the closure of all banks for several days. This action did not stop a run on the banks after they reopened and as a result of bank runs over 4,000 banks failed taking with them the saving of many millions of people.

Thereafter, President Roosevelt issued, on Apr. 6, 1933 Executive Order 6102 ordering the citizens of the United States to surrender their gold bullion, gold coin, and gold certificates, under penalty of law, by May 1, 1933, not to the U.S. government or U.S. Treasury, but instead to the privately-owned Federal Reserve banks in exchange for ‘irredeemable’ fiat-currency, backed by nothing, and issued by Federal Reserve. Executive Order 6102 specifically stated: “UNDER EXECUTIVE ORDER OF THE PRESIDENT all persons are required to deliver all GOLD COIN, GOLD BULLION, AND GOLD CERTIFICATES owned by them to a Federal Reserve Bank, branch, or agency, or to any member bank of the Federal Reserve System.” On Aug. 15, 1971 President Nixon, through Executive Order 11615 severed completely the last convertibility of the Federal Reserve Note into gold by foreign governments or foreign central banks, officially ending the link between the Federal Reserve currency and gold, to the present date. After the assassination of President Kennedy, President Johnson through the Coinage Act of 1965 demonetized silver from U.S. coinage, whereafter, U.S. coins were made from base metals, thus ending any precious metal backing to U.S. currency and coinage. Today, nearly the whole world is on a debt-based fiat-currency system operated by privately-owned central banks.

Since the usurpation of the U.S. monetary system in 1913, the value of the fiat-currency, or Federal Reserve Notes (FRN), has fallen ninety-nine percent (99%) in real money (as measured by gold) by the end of 2022, thereby proving conclusively that the FRN is not money, because it lacks the third element; that being “a store of value”. At the inception of the FRN, in 1914, gold was valued at $20.67/oz. and today gold is valued over $2,000/oz. The remaining last one-percent (1%) of “stored value” of the FRN is about to reach its “intrinsic value—zero” as Voltaire wisely forewarned us in 1729, nearing 200 years ago.

Since 1986, The United States Mint has minted 1 oz. silver coins, by law, having a stamped face value of $1.00, called America Eagle Silver Dollar or simply, Silver Eagles. Each Silver Eagle coin is one troy ounce or 99.9% pure silver. Over 400 million Silver Eagles have been struck and purchased by consumers as of mid-2020. In 2019 the U.S. Mint made and sold 14,863,500 Silver Eagle 1 oz. coins, and in 2020 the U.S. Mint made and sold 30,089,500 Silver Eagle coins, over twice as many because of growing consumer demand. The public is beginning to understand that their debt-based fiat-currency, FRN, will soon be worthless. Other privately minted 1 oz. silver rounds or tokens (as they are called because they are not issued by the government) have been issued and purchased by the consumer in quantities much greater than the number of the American Eagles, do to the higher commission cost of the Eagles, for the same silver content as 1 oz. silver rounds or tokens are.

Authorized by Congress under the Bullion Coin Act of 1985, the American Eagle 1 oz. gold coins have been produced by the U.S. Mint and are legal tender at face value of $50. However these 1 oz. gold Eagles are being sold by the U.S. Mint not at face value, or stated monetary value, but for over $2,000 per coin. The 1 oz. American Silver Eagle coin, stamped with a $1.00 face value, is currently being sold by the U.S. Mint for approximately $30.00 per coin.

As individuals wake up to the fact that the FRN is an irredeemable currency backed by nothing and is not money, because it lacks the element or quality of having “a store of value”, they will want to obtain silver and gold coins, tokens, or bars, or bills to preserve their purchasing power that silver and gold have provided for thousands of years.

In 2022, U.S. inflation rate is running at approximately eight-percent (8%) while interest rates on saving accounts are running less than two-percent (2%) thereby giving the saver more than a negative six-percent (6%) annual return on their bank savings. On the other hand the price of silver and gold coins continues to appreciate compared to FRN, while the value of the fiat FRN continues to depreciate relative to the value of silver and gold. The Federal Reserve system in fact controls inflation by the amount of FRNs, or its equivalent electronic digitized form, they inject, or have in the U.S. monetary-system and thereby they control the rate of inflation. As economist Milton Friedman famously said, “Inflation is always and everywhere a monetary phenomenon . . . ”. Inflation is a tax levied upon the American consumer by the privately-owned and operated Federal Reserve.

The reintroduction of real money, that being silver or gold, back into the U.S. economy begins with individuals, being able to take their coins, tokens, bars, and bills, made of silver or gold and exchange them on a ‘as needed basis’ for goods.

The number one draw back to owning silver and gold coins or tokens is that the consumer repeatedly says: “I cannot take silver or gold coins to the grocery store to buy food”. The present invention changes that.

There must be a step toward the return to a silver and gold monetary-system, and away from the current enslavement of the world's debt-based fiat-currency system owned and controlled by private central banks. That “step” is through the present invention.

All retailers and wholesalers selling groceries, throughout the United States, accept in exchange for their food or groceries or other goods only: (1) Federal Reserve Notes in the denominations of $1, $2, $5, $10, $20, $50, and $100 or (2) U.S. Treasury coinage in the denominations of 1, 5, 10, 25, and 50, cents in ‘base-metal’ coins, or (3) credit-card payment which all credit card companies accept only Federal Reserve Notes (FRN) as payment, or (4) debit-cards, gift-cards, prepaid cards, stored-value cards, or contactless cards, tokens on or through a open-loop or closed-loop system, were all purchased with FRNs.

Ben Bernanke was chairman of the Federal Reserve System when he appeared before a session of Congress where Congressman Ron Paul, on Jul. 18, 2013, asked Chairman Bernanke: “Is gold money?”, where Bernanke replied—“No”. “It's a precious metal”.

The following was taken from federalreserv.gov website: ““Federal Reserve notes are not redeemable in gold, silver, or any other commodity. Federal Reserve notes have not been redeemable in gold since Jan. 30, 1934, when the Congress amended Section 16 of the Federal Reserve Act to read: “The said [Federal Reserve] notes shall be obligations of the United States . . . . They shall be redeemed in lawful money on demand at the Treasury Department of the United States, in the city of Washington, District of Columbia, or at any Federal Reserve bank.” Federal Reserve notes have not been redeemable in silver since the 1960s.”” Today the FRN is only redeemable for itself.

Accordingly, gold and silver are not money they are precious metals and during the entire barter transaction as specified in claims of the present invention silver and gold coins, and or tokens, and or bars, and or bills do not represent currency or money, but represent a barter value or ‘bartered value’, where a tangible item of value is bartered or exchanged for another tangible item of value during the barter or barter transaction. According to the definition of “Legal Tender”—“coins and or banknotes recognized by law as money to settle a public or private debt or meet a financial obligation, including tax.” The U.S. government, like the Federal Reserve System, does not currently recognize gold and silver coins as legal tender, nor as being money.

In 2008 there was a financial crisis that almost took down the world's financial system that is today interconnected. The Federal Reserve injected into the financial system nearly four-trillion dollars to BAIL-OUT the banks to keep them from collapsing. The four-trillion dollars were created by the Federal Reserve with about thirteen key stokes on a computer. Since the obligation of all Federal Reserve Notes (I.O.U.s) are by contract an obligation of the U.S. Government, the U.S. citizens are on the hook for these I.O.U.s or debt obligations, now totaling more than $32,000,000,000,000. In 2008 the U.S. debt was nine-trillion dollars and of the beginning of 2023 the U.S. Debt is 32-trillion dollars. After the near collapse of the financial system in 2008 Congress in 2010 passed H.R.4173 or the Dodd-Frank Wall Street Reform Act which prevents another BAIL-OUT of the banks in the future. The Dodd-Frank law has made it legal for the banking system to do a BAIL-IN which calls for the banks to take, or steal, the depositor's money in a bankruptcy of the banks or banking system. Most individuals are unaware that when they deposit money into their bank account they are transferring their ownership in their money to the bank, whereupon they become an unsecured creditor, but still have lien, which may, in all likelihood, turn out to be worthless in a bankruptcy. And almost no one understands that unsecured bank depositors stand in line, in a bank bankruptcy, behind all of the financial derivatives, which currently amounts to over 200 trillion dollars. Therefore, bank depositors stand to lose everything they have in the bank in the near future. As this information leaks out, individuals will want to take money out of the banks and convert it, or barter it any way they can, before the banks fail or the FRN becomes worthless.

The U.S. Government and the Federal Reserve system are planning on recalling all Federal Reserve Notes in circulation and replacing them with the proposed Central Bank Digital Currency (CBDC)—see US Pat. App. No. 2020/0151682, 2022/0292470, “A former Federal Reserve executive believes it's only a matter of time before central banks adopt a form of digital currency”—(source: ITNews.com) which is an intangible and irredeemable currency that is a debt-based digital currency where every transaction using CBDC will be tracked and traced once the FRNs are withdrawn from use, and where accounts can be turned-off if the coming individual's social credit score is to low.

### BRIEF SUMMARY OF THE PRESENT INVENTION

It is an object of the present invention to reintroduce silver and gold back into the U.S. monetary-system using the method of the present invention.

It is another object of the present invention to offer a way to protect the individual from losing a portion of their money in the current banking system that is vulnerable to collapse and insolvency.

It is another object of the present invention to allow the individual possessing coins, tokens, bills, and bill, made of gold or silver to wait until the last moment to barter these possessions of coins, tokens, bars, and bills made of silver or gold for food or other groceries and goods, thus enabling the individual to reduce his exposure to the ongoing depreciation of FRNs.

It is another object of the invention to save the individual considerable time in exchanging his or her coins, tokens, bars, and bill, made of gold by the individual not having to ship via FEDEX, or UPS, or USPS to a coin dealer and waiting for a week or two turn around time for the coin dealer to issue a check in FRNs and mail it, or direct deposit FRNs, or their electronic equivalent, into the individual's bank account.

It is another object of the present invention is to reduce the cost of bartering an individual's coins, tokens, bars, and bills, made of silver or gold by not having to exchange said coins, tokens, bars, and bills with a distant coin dealer but instead with a local retailer or wholesaler who sells and or barters food or other groceries and goods. The individual currently has to travel by auto, maybe considerable distance, to the coin shop or coin dealer to sell his silver or gold coins, or the like. On the other hand he may sell his silver and gold coins, and the like, to a dealer hundreds of miles away where it is necessary to ship by USPS, FEDEX, UPS where shipping and insurance charges can be substantial, keeping in mind that silver and gold are especially heavy metals and shipping charges are determined by the weight.

It is another object of the present invention to create substantial savings for the retailer or wholesaler who barters food and other groceries and goods in exchange for coins, tokens, bars, and bills, made of silver or gold, owned by an local individual by not having to pay for incoming shipping or freight charges on these heavy items from a distant coin dealer or distributor.

It is another object of the present invention to create the opportunity for the retailer or wholesaler to sell or resell silver and gold coins, tokens, bars, and bills to their customers who are looking to hedge against inflation, thereby increasing the sales and profits of the retailer and wholesaler that sell groceries thus increasing their chance of survival in an economic downturn.

It is another object of the present invention to create a competitive advantage to the retailer or wholesaler since coin dealers have to pay silver and gold refiners and mints the cost of in-bound freight or shipping on their purchase of coins, tokens, bars, and bills, made of silver or gold and wherein this cost is passed along, whereas said individual bring in their coins, tokens, bars, and bills to said retailer or wholesaler that sells groceries and therefore does not incur any in-bound shipping costs, thereby enabling said retailer or wholesaler to be able to turn around and sell or resell these coins, tokens, bars, and bills at a lower price to their customers which amounts to a cost savings through the present invention.

It is another object of the present invention is to make the process of purchasing and selling of coins, tokens, bars, and bills, made of silver or gold much more efficient and cheaper to the individual and to the public at large.

It is another object of the present invention to present to said retailer or wholesaler a financial advantage to use the method of the present invention wherein the individual does not want to exchange his or her coins, tokens, bars, or bills, made of silver or gold, for FRNs, for reasons already explained, but instead the individual wants to receive, on an intermediate step, a ‘bartered value’ card (BVC), or its equivalent, having been assigned the ‘bartered value’ during the barter transaction where the ‘bartered value’ can be used immediately or over time to complete the barter transaction which results in a savings to the retailer or wholesaler because their was no exchange in FRNs, which effects, favorably, the retailer's or wholesaler's cashflow.

In summary do to debt-based fiat-currencies, like the FRNs, still being issued and used as the only source of money and currency in today's U.S. society and do to their ongoing depreciation of these FRNs against the value of coins, tokens, bars, and bills, made of silver or gold, it is the growing desire, among individuals, to exchange FRNs as quickly as possible with coins, tokens, bars, and bill made of silver or gold. However the individual needs to eat and the individual cannot eat silver or gold, nor buy food or other groceries with silver or gold.

Through the present invention, the individual simply takes his or her coins, and or tokens, and or bars, and or bills, made of silver and gold to the retailer's or wholesaler's customer service counter that is set up and authorized to handle barter transaction involving coins, or tokens, bars, or bills, made of silver or gold and staffed by at least one authorized employee or agent that has been trained and authorized by the retailer or wholesaler or it agent to handle and transact barter involving coins, tokens, bars, and bills, made of silver and gold. Whereupon, receiving from the individual his or her coins, and or tokens, and or bars, and or bills, made of silver gold the authorized employee or agent using the electronic communications devices at the authorized customer service counter records the barter transaction including at least the name of the individual and performs an inspection and evaluation of the coins, and or tokens, and or bars, and or bills, using protocol established or approved by the retailer or wholesaler and accepts or rejects, some or all of the coins, tokens, bars, and or bills, made of silver or gold. Whereafter, accepting coins and or tokens, and or bars, and or bills for barter the authorized employee or authorized agent makes the individual an barter offer, or its equivalent, using protocol approved or authorized by the retailer or wholesaler and using an electronic communications network device, that is connected to the internet, at the authorized customer service counter to determine the barter offer, where the individual upon his or her acceptance of the barter offer receives in exchange a Bartered Value Card (BVC) where the authorized employee assigns the BVC a ‘bartered value’ using an electronic card/token reader/writer device connected to the communications network at the authorized customer service counter and has recorded the unique identifying number or code assigned to the BVC to the barter transaction record being made an official record of the barter transaction preserved by the retailer or wholesaler, where the ‘bartered value’ on the BVC remains a liability of the retailer or wholesaler until the barter transaction is complete, which results when the ‘bartered value’ on the BVC has no more ‘bartered value’ on the BVC.

The BVC can be a magnetic stripe card having an unique identifying number or code, or it can be a card with a microchip having an unique identifying number or code, or it can be a passive transponder chip card (with an antenna) or token with an unique identifying code or similar devices that can be read or be assigned numeric, or alphanumeric, or binary code data by an electronic communications device.

Similar cards now in existence are called: ‘gift cards’, ‘prepaid cards’, ‘stored value cards’ (SVC), ‘stored value tokens’ (SVT), ‘access card’, store credit cards. However, all of these cards are different than a BVC. Gift cards, prepaid cads, and the like, are purchased with FRNs and have their value assigned to the card, whereafter they are purchased by the consumer with the value already loaded on the card for an amount that includes the amount spent for the card. Whereas the BVC typically has no value on the card before the barter. Based on current U.S. Government legal regulations there are certain rules governing these cards or “gift card”, and the like. The law states; “The maximum amount that can be purchased by a single person across multiple gift cards is $10,000. The maximum amount that can be purchased by a single person for a single brand is $2,000.” “Gift cards”, and the like, are all purchased with a certain dollar (FRN) amount already on the card at time of purchase, or are loaded with a dollar amount at time of purchase at checkout. The purchase of these “gift cards”, and the like, require the purchase to be made in Federal Reserve Notes (FRNs) currency. The present invention and the method thereof concerns a barter or barter transaction involving one commodity (silver and or gold) for another commodity (food or groceries) and is not purchased for, nor exchanged for, or refunded for dollars or FRNs and therefore is not subject to the U.S. Government laws that effect or regulate “gift cards”, prepaid cards, or the like. Nor is a BVC a store credit card, where credit is being given by a retailer or wholesaler for the return of merchandise by an individual where a store credit is applied to a card, or a stored value card (SVC), or a debit card. A BVC is not a ‘gift card’ or a ‘prepaid card’, or the like, it is a bartered value card (BVC) involving barter where the ‘bartered value’ is not money or currency, as defined by the Federal Reserve and U.S. Government.

### BRIEF DESCRIPTION OF THE DRAWINGS

The drawings are provided to illustrate certain embodiments described herein. The drawings are merely illustrative and are not intended to limit the scope of claims invention and are not intended to show every potential feature or embodiment of the claimed invention. The drawings are not necessarily drawn to scale; in some instances, certain elements of the drawing may be enlarged with respect to other element of the drawing for purposes of illustration.

FIG. 1 illustrates an embodiment of the present invention showing the barter of coin, token, bar, and bar, made of silver or gold for groceries with an intermediate step of involving the use of a Barter Value Card (BVC)

FIG. 2 illustrates an embodiment of the present invention showing the individual presenting his or her coin, token, bar, and bill to an authorized employee/agent, at the retailer's or wholesaler's authorized customer service counter equipped an authorized to handle barter transactions.

FIG. 3 illustrates an example of authorized customer service counter at a retailer or wholesaler that sells or barters food or other groceries and goods in exchange for silver of gold coin, and or token, and or bar, and or bill, possessed and owned by an individual.

Flow chart illustrates the method showing a method

FIG. 4 illustrates the method in further detail in accordance of the present disclosure.

FIG. 5 illustrates the method for supplying communication service according to an embodiment of the present disclosure

FIG. 6 illustrates an exemplary flowchart continuation for the barter transaction

FIG. 7 illustrates an exemplary flowchart continuation for the barter transaction

FIG. 8 illustrates an exemplary flowchart continuation for the barter transaction

FIG. 9 illustrates an exemplary flowchart continuation for the barter transaction

other arrangements of the present invention are possible and, consequently, the accompanying drawings are not to be understood as superseding the generality of the description of the invention.

### DETAILED DESCRIPTION OF THE PREFERRED EMBODIMENTS

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

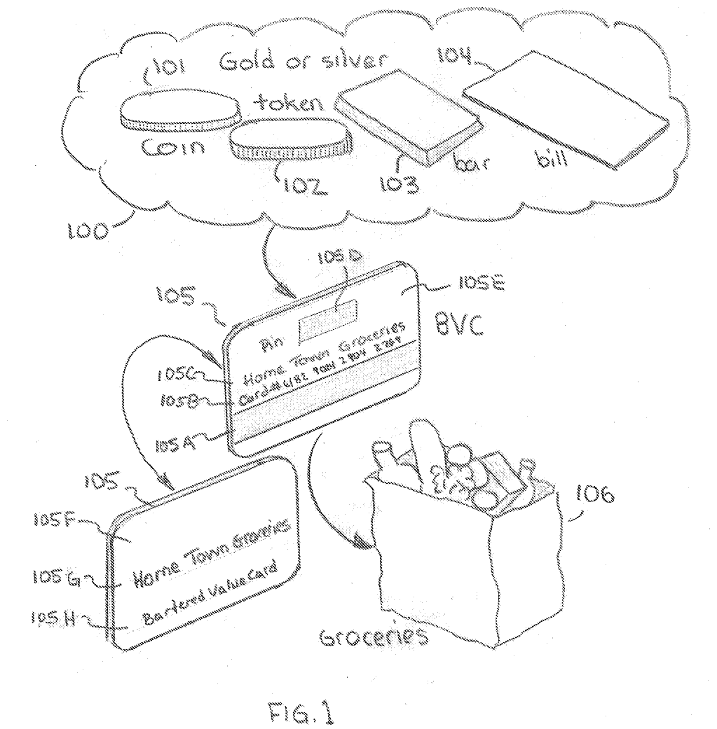

FIG. 1 illustrates an exemplary embodiment of the present invention where a grouping of silver or gold items 100 to barter are depicted that include a coin 101, a token 102, a bar 103, and a bill 104 all made of silver or gold. Where the coin 101 represents any government issued silver or gold coin 101, usually containing one troy ounce of either silver or gold. The U.S. Mint makes or mints 1 oz troy silver American Eagles coins stamped with a $1 face value, but is currently being sold for approximately $30 through their “Authorized Purchasers” which are select coin dealers or coin distributors. The silver content of an American Silver Eagle is 0.999. The U.S. Mint also makes or mints 1 oz gold American Eagles coins stamped with a face vale of $50, but is currently being sold for more than $2,000 through their “Authorized Purchasers”. The gold content of an American Gold Eagle is 0.999. So in effect the public has to pay 30 times the face value for their silver coins, while the public has to pay more than 40 times the face value for American Eagle gold coins. Yet, the usmint.gov website states: “Congressionally authorized, American Eagle Bullion Coins are minted and issued by the United States Mint. They are intended to provide investors with convenient and cost-effective way to invest in precious metals”. Token 102 (or rounds as they are normally called) is also made of silver or gold and it too is generally made of 1 troy oz. The difference between a token 102 and a coin 101 is the coin 101 is minted by an official governmental entity or agency while a token 102 or round is minted or made by a private mint or manufacturer. Tokens are never stamped with a face value and are sold for its precious metal content by weight. Although the U.S. Mint states: there coins “are intended to provide investors with convenient and cost-effective way to invest in precious metals” it is proven that silver tokens and rounds are a much more “convenient and cost-effective way to invest in precious metals” as they are always substantially less in price or cost and more readily available than the U.S. Mint silver and golds coins are. Silver tokens 102 are usually made of 1 troy oz of silver, while the gold coins usually are offered in 1 oz, ½ oz, ¼ oz, and 1/10 oz weights. The Royal Canadian Mint, and Australian Mint, the South African Mint and several countries offer their coins in the same weight demonization. Privately minted silver and gold tokens 102 (or rounds) are extremely popular with many individuals as they feel why should one pay more for the same weight of precious metal. If one is buying for their precious metal content why should one pay more for a coin than a token if both are one ounce of silver or gold? Silver and gold bars 103 (or bullion as often called) are mainly minted by private mints where the bar weight for silver is usually—1 oz, 5 oz, 10 oz, 100 oz, or 1000 oz for silver and for gold—1 gram, 2 grams, 2.5 grams, 5 grams, 10 grams, 20 grams, 50 grams, 100 grams, 250 grams, 500 grams, 1 oz, 10 oz. Bill 104 are relatively new (Google: ‘Goldbacks’) and are made using a technology of electrostatically applying 24 KT gold particles to a flat thin plastic film to create a gold bill 104 and are offered in 1/1000th oz, 1/500th oz, 1/250th oz, and 1/100th oz bill denominations. This grouping 100 of silver or gold coin, token, bar, and or bill, can be bartered for groceries 106 using an intermediate step in the barter transaction process which is through a Barter Transaction Card (BVC) 105 or Bartered Transaction Card (BVC) 105 (or its equivalent), which is one and the same for illustrative purpose, which can be a magnetic stripe card, or mag-stripe/smart-chip card, or passive transponder chip card or token with or without a mag-stripe, or a smart chip card, and or a UPC card, and or a QR Code card. Where the BVC 105 can have a mag-stripe 105A or a magnetic stripe 105A and has a unique identifying card number or code 105B and where the BVC 105 further can have the name of the issuer 105C printed backside 105E of the BVC 105 and on the frontside 105F can appear the name of the issuer 105G and further can have a logo 105H and where BVC 105 can be loaded through or by an electronic card reader/writer, or the like, with bartered value (not shown) from said barter that can be exchanged for food or other groceries and or goods at a retailer or wholesaler that sells and or barters food or other groceries and goods.

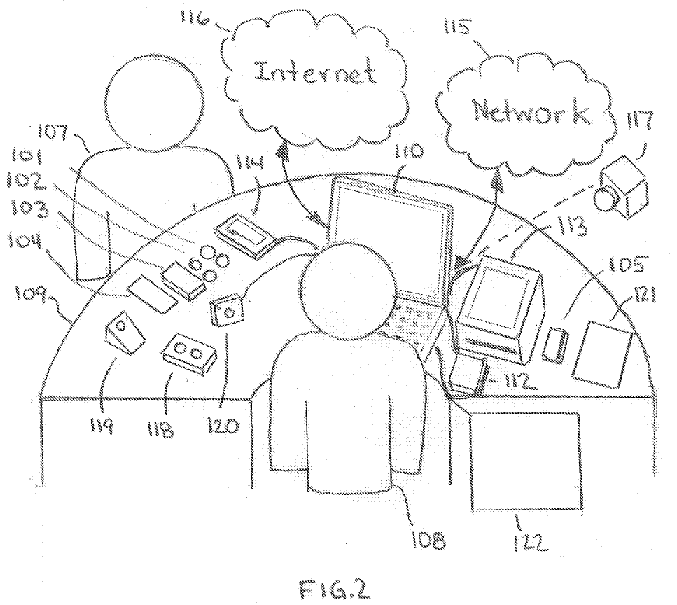

FIG. 2 illustrates an exemplary embodiment of the present invention where individual 107 possessing and owning coin 101, token 102, bar 103, and bill 104 presents to authorized employee/agent 108 at authorized customer service counter 109 coin 101, token 102, bar 103, and bill 104 and lays on service counter 109 that is approved or authorized to handle barter transactions involving silver or gold, coins, tokens, bars, and bills by the retailer or wholesaler, where authorized employee/agent 108 begins the barter transaction using retailer's/wholesaler's electronic communications network 115 that can be a closed loop system connected to a electronic card reader/writer 112 and a electronic terminal with 110 or an electronic computer device 110 and printer 112 and electronic signature pad 114 or it can also be connected to a computer device 110 that is connected to the internet 116 where the communications network 115 further is connected to an electronic card/token reader/writer 112, electronic printer 113, electric signature pad 114, electronic camera 117 and or electronic camera 120, is connected to said electronic communications network 115, and connected to CPU 122 (if required), and where authorized employee(s)/agent(s) use during the inspection process one or more devices or methods, such as coin size gauge 118 or coin slide 119 to determine authenticity of said coins, and where Barter Transaction Form (BTF) 121 and shown is a BarterValue Card (BVC) 105 that have yet turned into a Bartered Value Card (BVC) 105 (not shown).

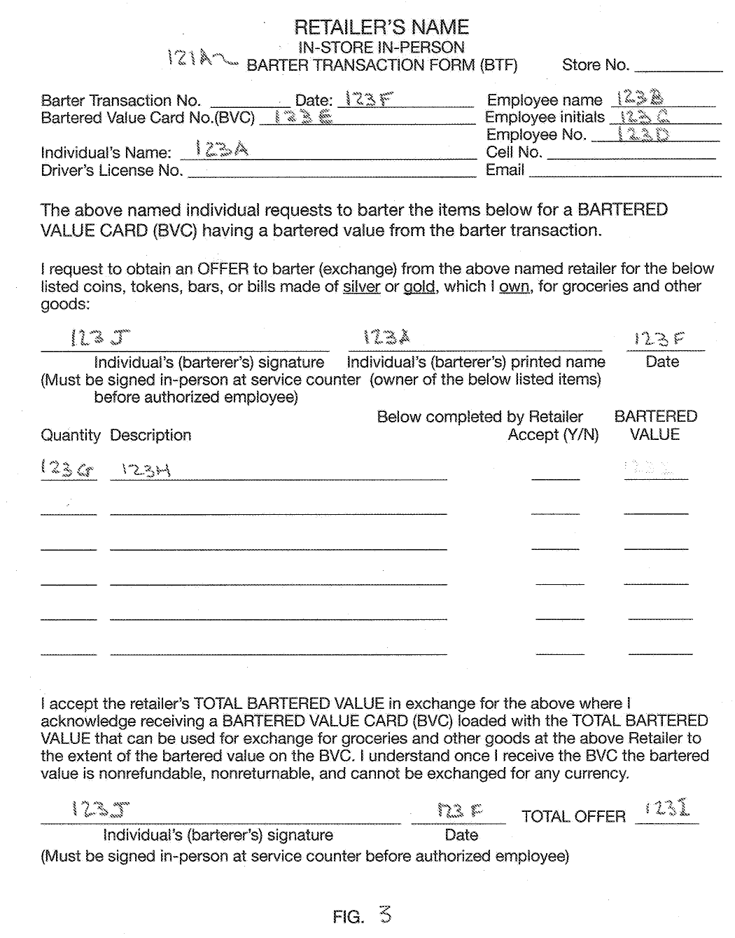

FIG. 3 displays an example of an In-Store, In-Person Barter Transaction Form (BTF) 121A used by the Retailer or Wholesaler and authorized employee(s)/agent(s) to collect, record, and complete information during said barter transaction, where the individual (barterer) appears in-person, in-store without filing an online BTF, and where some or all of the information requested or shown on BTF 121A may be required or at a required minimum: the name of individual (barterer) 123A, and the name of authorized employee/agent 123B and or initials of the authorized employee/agent 123C, and or the number or code 123D of the authorized employee/agent, and the Bartered Value Card (BVC) identification number 123E, the date of the bartered transaction 123F, and the quantity 123G and description 123H and assigned barter value or bartered value 123I of said coin(s), token(s), bar(s), and bill(s) and the signature 123J of the individual accepting the barter or bartered transaction. It should be understood that many examples of a Barter Transaction Form (BTF) could be presented herein showing an in-store in-person BTF, what is showing is just one example. Each individual Retailer or Wholesaler will have their own requirements for a Barter Transaction Form (BTF), or its equivalent. BTF 121A is merely an example of one form and is self explanatory.

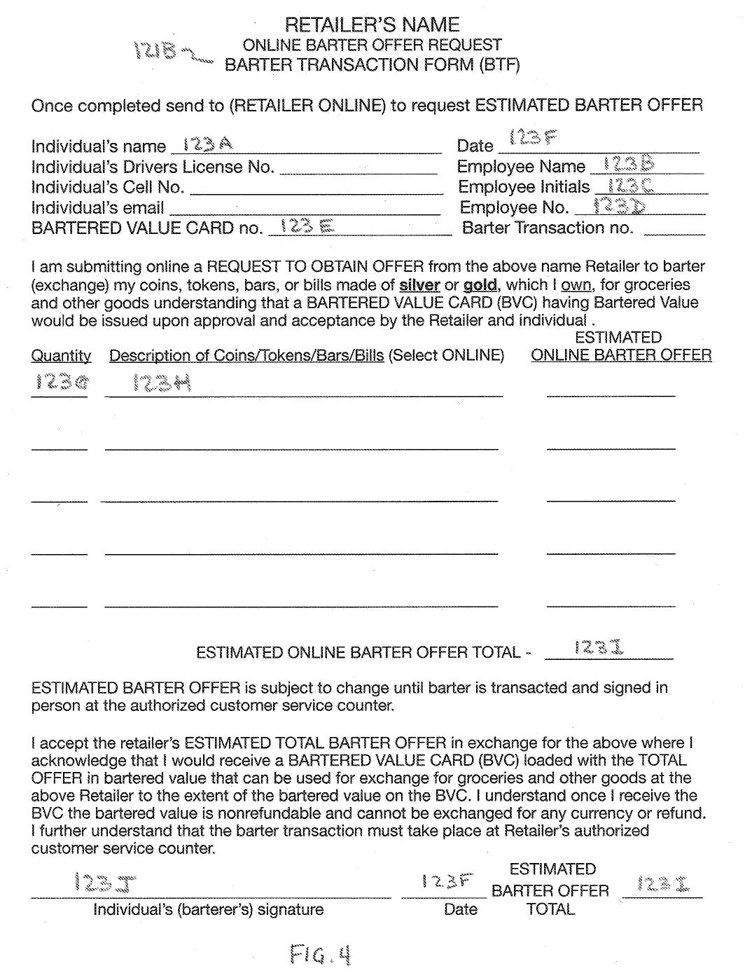

FIG. 4 displays an example of an Online Barter Transaction Form (BTF) 121B initiated by the individual and used by the Retailer or Wholesale and authorized employee(s)/agent(s) to collect, record, and complete information during the barter transaction, where the individual (barterer) has filled out and filed, at least partially, an ONLINE Barter Transaction Form (BTF) 121B, where the individual can log into an internet website, owned by the retailer or wholesaler or associated with or authorized by said retailer of wholesaler, where a program is designed to automatically value a barter value which then is assigned to BTF 121B once the coin(s), token(s), bar(s), and bill(s) are identified 123H on Form 121B and where the individual completes and signs 123J, electronically or manually, and dated 123F, and sends via internet or email to the Retailer or Wholesaler, where at least the individual's name 123A and quantity 123G and description 123H of coin(s), token(s), bar(s), and or bill(s) have been entered on the BTF 121B along with the individual's signature 123J attesting to ownership of the items to be bartered and acknowledgment that the individual will receive a Bartered Value Card (BVC), or its equivalent, having a BVC no. 123E where said BVC has or will have bartered value 123I in exchanged for bartered items and where on form 121B has the name of the authorized employee/agent 123B and or the initials 123C of the authorized employee/agent and or the authorized employee/agent no. or code 123D. It should understood that the individual may only compete a portion of BTF 121B and may print it out and give it to an authorized employee/agent in person to complete. The authorized employee(s) or authorized agent(s) must during the barter transaction use an authorized program and or website authorized by the retailer or wholesaler to obtain a barter value to assign to the barter transaction and this is accomplished by using the electronic communications network. BTF 121B should be self explanatory.

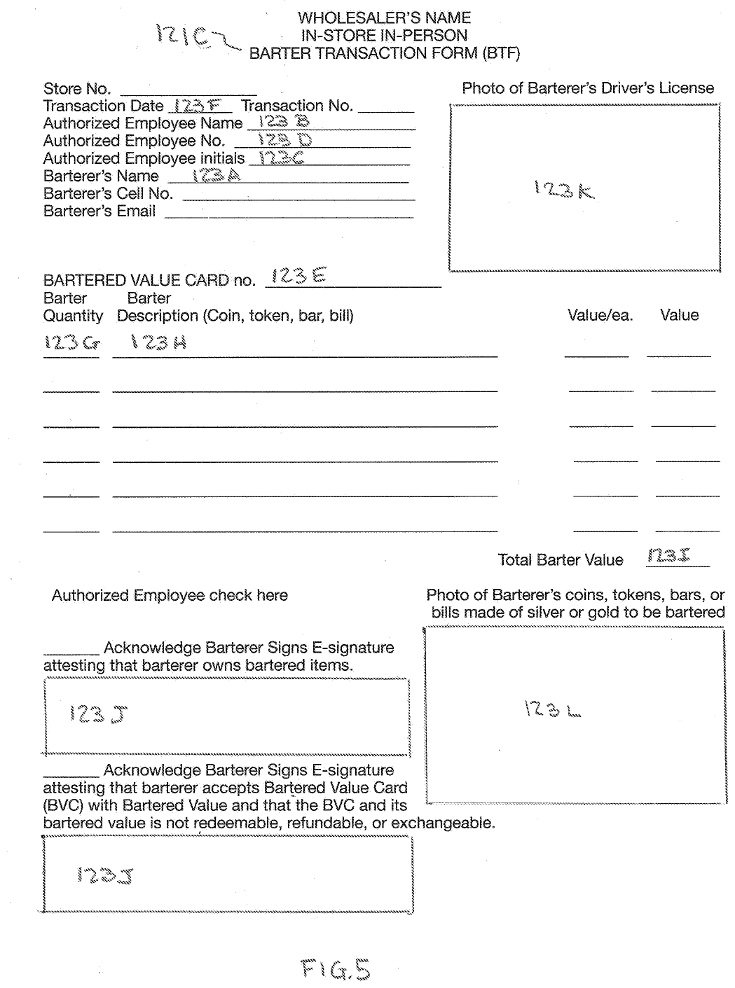

FIG. 5 displays another example of a In-Person, In-Store Barter Transaction Form (BTF) 121C used by the Retailer or Wholesaler and authorized employee(s)/agent(s) to collect, record, and complete information during the barter transaction, where the individual (barterer) appears in-store, in-person without previously filing online a BTF 121 and where the authorized employee/agent initiates the BTF 121C (or its equivalent or a variation thereof) and in this example of a BTF 121C the authorized employee/agent according to protocol established by the Retailer or Wholesaler, or its approved agent, which may require all, or some of, the information or blanks on this form be completed or at least a minimum which requires the name of the individual 123A, the name of the authorized employee/agent 123B and or the authorized employee/agent number or code 123D, the quantity 123G and description 123H of the bartered items, the bartered value assigned to the barter transaction 123I, the date of the barter transaction 123F, and at least one signature of the individual (barterer) 123J by manual or electronic means, and the BVC unique identifying number or code 123E. BTF 121C also show a box 123K to receive a phot of the barterer's (individual's) Driver's Licenses, and a box 123L to receive a photo of bartered coin(s), token(s), bar(s), and or bill(s).

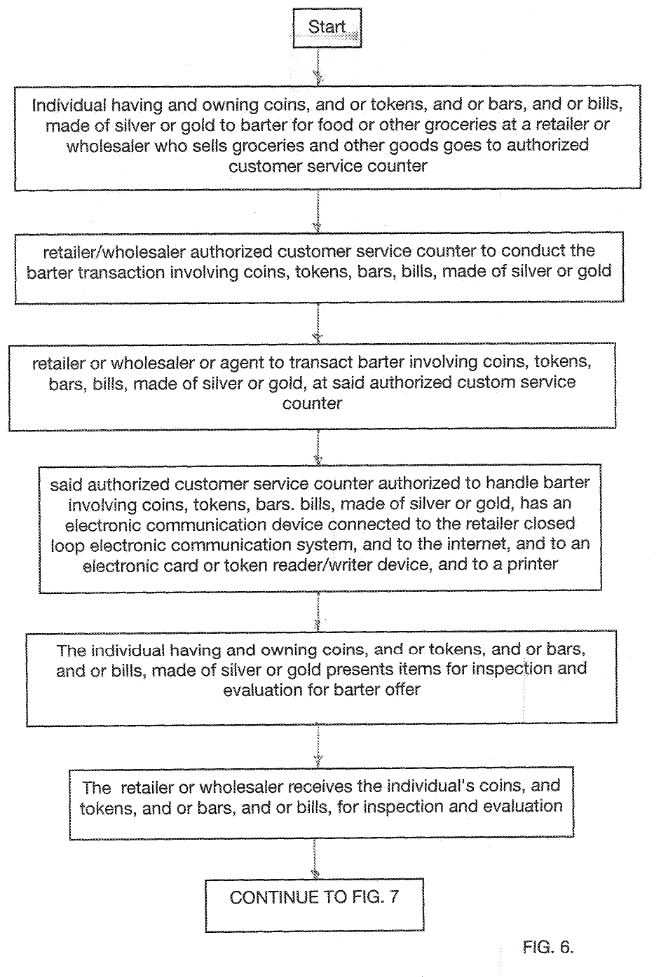

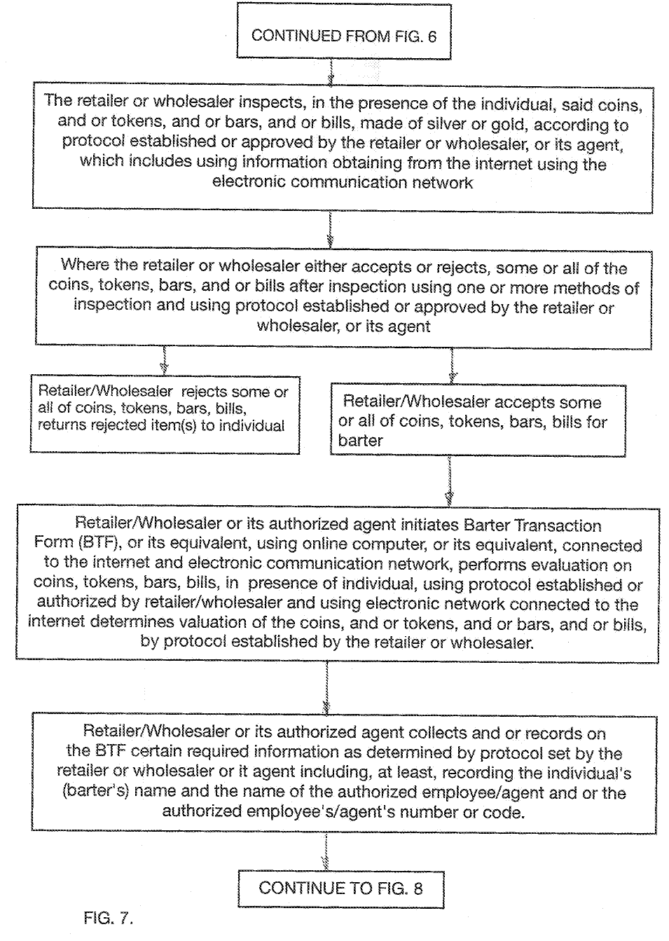

FIG. 6 illustrates a flow chart of the method of the present invention which should be self explanatory from its description and which is continued on FIG. 7.

FIG. 7 illustrates a flow chart of the method of the present invention and which should be self explanatory from its description and which is a continuation from FIG. 6.

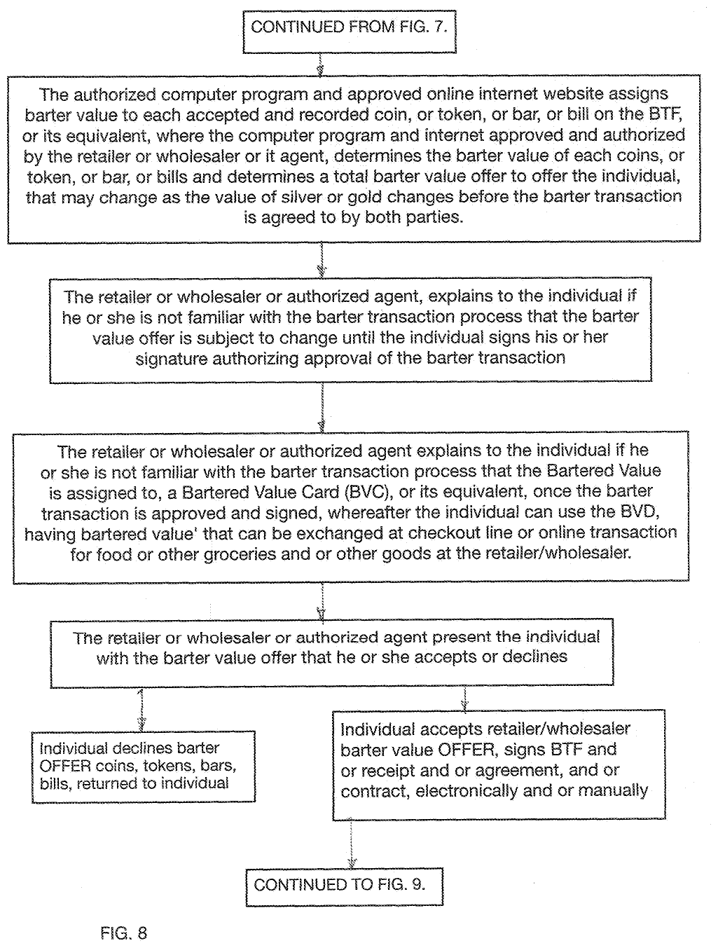

FIG. 8 illustrates a flowchart of the method of the present invention and which should be self explanatory from its description and which is a continuation from FIG. 7.

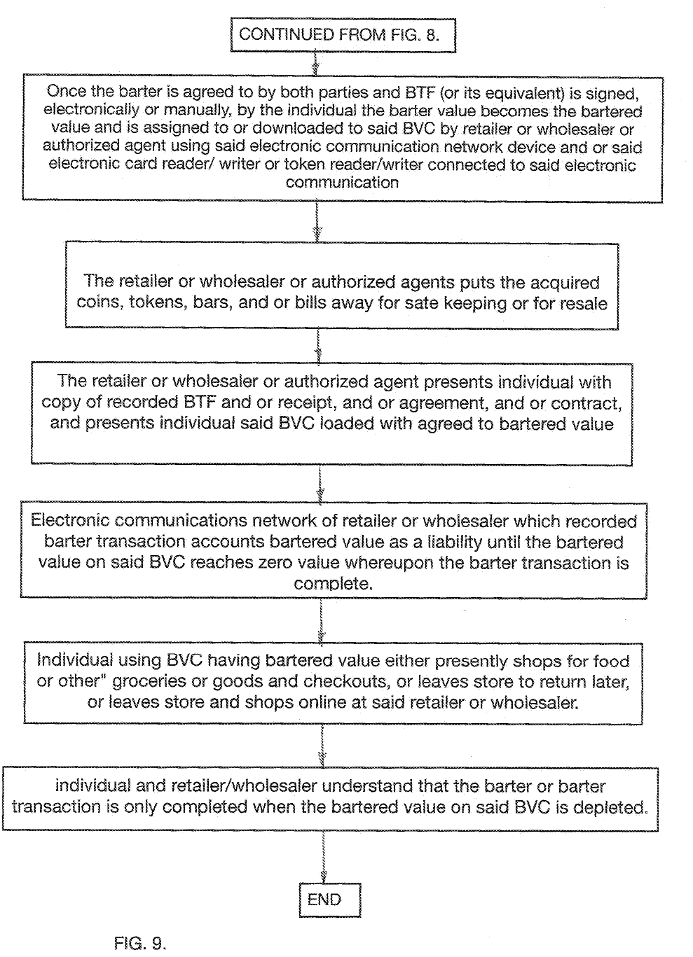

FIG. 9 illustrates a flowchart of the method of the present invention and which should be self explanatory from its description and which is a continuation from FIG. 8.

### Definitions

The following terms and phrases have the meaning indicated below, unless otherwise provided herein. This disclosure may employ other terms and phrases not expressly defined herein. Such other terms and phases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

BARTER: an exchange of coin(s), and or token(s), and or bar(s), and or bill(s), made of silver or gold for food or other groceries or goods at a retailer or wholesaler that sells groceries and other goods, without using any nation's debt-based fiat-currency including the Federal Reserve Note (FRN) currency or Central Bank Digital Currency (CBDC).

BARTER TRANSACTION: a transaction involving between and individual and a retailer or wholesaler, where an individual barters his or her coin(s), and or token(s), and or bar(s), and or bill(s), made of silver or gold for food or other groceries and goods, and where the retailer or wholesaler sells groceries and other goods who barters groceries and other goods with an individual possessing and owing coin(s), token(s), bar(s), and or bill(s), made of silver or gold, without transacting in any nation's debt-based fiat-currency including the Federal Reserve Note (FRN) currency or Central Bank Digital Currency (CBDC).

EXCHANGE: the act of barter or transferring ownership of one tangible thing for receiving another tangible thing in return, such as silver or gold coin for food or groceries.

FIAT COIN: a flat, typically round piece of metal made of base metal(s), with an official stamp or impression of a Nation, including a stamped numerical value that is exchanged at the stamped value and used as money or a medium of exchange of a Nation.

SILVER COIN: a flat, typically round piece of metal made of at least ninety-percent silver, with an official stamp or impression of a Nation and or is issued by a Nation, further including a numerical value that may have been was used as money in the past, but is not valued, or bartered or exchanged at the stamped numerical value today.

GOLD COIN: a flat, typically round piece of metal made of at least ninety-percent gold, with an official stamp or impression of a Nation and or is issued by a Nation, including a stamped numerical value that may have been used as money in the past, but is not be valued, bartered or exchanged, at the stamped numerical value today.

SILVER TOKEN: a flat, typically round or rectangular piece of metal made of at least ninety-percent silver with an impression on one or both sides that includes an impression showing weight of the token and is minted, made, or sold by a private mint or company and is currently referred to as a precious metal or silver “round” or “token” and not as money as no value is stamped on the token.

GOLD TOKEN: a flat, typically round or rectangular piece of metal made of at least ninety-percent gold with a impression on one or both sides that includes an impression showing weight of the token and is minted, made, or sold by a private mint or company and is currently referred to as a precious metal “round” or “token” and not as money as no value is stamped on the token.

SILVER BAR: a typically rectangular piece of thick metal in the shape of a bar or ingot made of at least ninety-percent silver with a impression typically on one side that includes an impression or stamp showing weight of the bar, typically 1 oz., 5 oz., 10 oz., Kilo, 100 oz., 1000 oz. and are often called, or are known as bullion.

GOLD BAR: a typically rectangular piece of thick metal in the shape of a bar or ingot made of at least ninety-percent gold with a impression typically on one side that includes an impression or stamp showing weight of the bar, typically: 1 gram, 2.5 grams, 5 grams, 10 grams, 20 grams, 50 grams, 100 grams, 1 oz., 5 oz., 10 oz., 10 oz., 1 Kilo and are often called or known as bullion.

SILVER BILL: a flat, typically thin rectangular plastic film where silver, made of at least ninety-percent silver, is attached, or laminated, or coated to at least one layer of plastic film creating a bill. See U.S. Pat. No. 5,120,589

GOLD BILL: a flat, typically thin rectangular plastic film where gold, made least ninety-percent gold, is attached, or laminated, or coated to at least one layer of plastic film creating a bill. See U.S. Pat. No. 5,120,589

BANKNOTE or NOTE: (such as the Federal Reserve Note—FRN): flat usually rectangular piece of paper, or cotton and linen (FRN is made of 75% cotton and 25% linen), or a flat usually rectangular piece of plastic and designated by a Nation as money (that can be used to pay taxes), constituting a central bank's promissory note, or I.O.U., to pay a stated amount to the bearer on demand, but, in fact today is irredeemable for any thing other than itself, since gold and silver backing has been eliminated. The FRN has been designated by the U.S. Government or the Federal Reserve to be a: “note that is legal tender for all debts, public and private”.

FIAT MONEY: is money made or printed by governments and distributed by privately owned central banks and decreed toy governments to be legal tender for all debts, public and private, including taxes, and is not redeemable for silver or gold or anything, other than itself, and therefore is irredeemable.

FRN: Federal Reserve Note authorized under the 1913 Federal Reserve Act was a currency note redeemable in silver or gold coin, but today is irredeemable which means it is no longer backed or exchangeable for silver or gold, and in fact is a debt-backed fiat currency.

MONEY: currently, a unit of something that is accepted as payment for all goods and services and payment of debts, such as federal and state taxes, and considered money by a Nation.

CURRENCY: a system of money, issued by or for a Nation, in the form of banknotes and coins legalized by a nation to pay taxes.

BARTER VALUE: a value associated with a barter transaction where an authorized employee or authorized agent of the retailer or wholesaler makes an OFFER having barter value to an individual using protocol established or authorized by the retailer or wholesaler or it authorized agent and that may or may not accept the OFFER or barter value during the barter transaction.

BARTERED VALUE: a value associated with a barter transaction between two parties where both parties of the barter have accepted and agreed upon an offer of barter or barter value which thereafter becomes ‘bartered value’ which is assigned electronically to a Bartered Value Card (BVC), or its equivalent, as an intermediate step in the barter transaction, using an electronic communications network and device connected to the retailer's or wholesaler's communications network including a card/token reader/writer where the ‘bartered value’ is loaded to, or in, or assigned to the BVC and said ‘bartered value’ can be exchanged for food or other groceries and goods until the ‘bartered value reaches zero whereupon the barter transaction is completed.

BARTERED VALUE CARD (BVC): generally a thin rectangular plastic card, typically the size of a credit card, that has an unique identifying card number or code assigned to, or upon and or within said card and where said card has one or more of the following features: a magnetic stripe, a mag-stripe, a microchip, a microchip connected to an antenna, a UPC code, a QR Code, a pin code beneath a scratch-off ink, and where said card can be or is assigned coded information including some or all of the following: ‘BARTERED VALUE’, unique identifying number or code, pin number or verification code, expiration date, name of card owner, that can be read, or written, or changed by an electronic card reader or electronic reader/writer connected to the closed-loop electronic communication network of the retailer or wholesaler.

IN-PERSON: where an individual appears physically before another individual such as an authorized employee or authorized agent of the retailer or wholesaler.

INTERMEDIATE: (1) being, situated, or acting between two points, stages, or things (source dictionary.com), (2) being between two other related things, levels, or points (source: dictionary.cambridge.org), (3) being or occurring at the middle place, stage, or degree or between extremes” (source: meriam-webster.com). Example: The exchanging of coin(s), token(s), bar(s), bill(s), made of silver or gold for a BVC, or its equivalent, having been assigned bartered value to further exchange for food or other groceries or goods is an intermediate step in the barter transaction.

PROTOCOL: a system of rules or procedures set by the management of the retailer or wholesaler for authorized employees or authorized agents to follow when transacting barter involving coins, tokens, bars, and bills, made of silver or gold, in exchange for food or groceries and or other goods. (collinsdictionary.com—“is a system of rules about the correct way to act in formal situations”.

EVALUATION: the making of a judgment about the amount, number, or value of something.

CLOSED LOOP: is a system of processing bartered value cards, or stored value cards, or gift cards, having value using an electronic communication network owned or controlled by the retailer or wholesaler, where it is not accessible to other retailers or wholesalers, and where the card or cards can only be used or processed to redeem bartered value or stored value within the retailer or wholesaler who issued said card or cards.

It will be apparent to those skilled in the art that modifications may be made without departing from the spirit and scope of the disclosure. The embodiments described are representative only, and are not intended to be limiting. Many variations, combinations, and modifications of the applications disclosed herein are possible and are within the scope of the disclosure. Accordingly, the scope of protection is not limited by the description set out above, but is defined by the claims which follow, that scope including all equivalents of the subject matter of the claims.

What is claimed is:

1. A method for transacting barter between: (a) an individual possessing and owning coin(s), and or token(s), and or bar(s), and or bill(s), made of silver or gold, to barter for food or other groceries and goods at a retailer or wholesaler that sells food and other groceries and goods, and (b) a retailer or wholesaler who sells food and other groceries and goods and who barters food and other groceries and goods with an individual for coin(s), and or token(s), and or bar(s), and or bills), made of silver or gold, with an intermediate step of using a Bartered Value Card (BVC), or its equivalent, during the barter transaction; further comprising;
(a) where the individual appears in-person at an authorized customer service counter of the retailer or wholesaler, where the retailer or wholesaler receive, inspect, and evaluate coins, tokens, bars, and bills, made of silver or gold for barter, and
(b) where the individual appears before the retailer or wholesaler at authorized customer service counter to handle barter involving coins, tokens, bars, and bills made of silver or gold, and
(c) where the authorized customer service counter is equipped to transact barter of coins, tokens, bars, and bills, made of silver or gold by having: (1) an electronic communications network device connected to a closed-loop electronic network system of the retailer or wholesaler, and (2) an electronic card reader/writer and or token reader/writer connected to an electronic communications network device that can read and or write magnetic stripe cards, and or a mag-stripe cards, and or microchip cards, and or microchip tokens, and or smart chip cards or tokens, and or a magnetic stripe/smart-chip card, and or contactless microchip card, and or UPC code cards, and or two-dimensional matrix code cards, and or the like, and (3) an electronic printer connected to the electronic communications network device capable of transmitting and receiving, and or printing, and or storing a customer receipt, and or agreement, and or contract, and or Barter Transaction Form (BTF), and (4) access to an electronic communications network device able to obtain current value of silver and or gold, and or current value of coins, and or tokens and or bars, and or bills, made of silver or gold, with using a special computer program, and (5) one or more devices and or methods to help the retailer or wholesaler in inspecting and or evaluating the individual's coin(s), and or token(s), and or bar(s), and or bills), made of silver or gold during barter transaction, and
(d) where the retailer or wholesaler inspects and evaluates the coins, tokens, bars, and or bills during the barter transaction using protocol established and or approved by the retailer or wholesaler and or its authorized agent and accepts or rejects some or all of said coin(s), token(s), bar(s), and bills) for barter according to said protocol, and
(e) where said retailer or wholesaler upon accepting for barter, some or all of, the coin(s) and or token(s), and or bar(s), and or bill(s), made of silver or gold offered by the individual, prepares a barter value (offer) for the individual using said protocol from the retailer or wholesaler or its authorized agents and information obtain from using an electronic communications network device at the authorized customer service counter, and
(f) where during the barter transaction the retailer or wholesaler using the electronic communications network device or computer at the authorized customer service counter prepares a Form or receipt, and or agreement, and or contract, and or Barter Transaction Form (BTF), or its equivalent, with an offer, and identifies and records the barter transaction which includes, at least: the date of the barter transaction, the name of the individual (barterer) and or signature and or driver's license number, the quantity and description of items accepted for barter, the name and or signature and or number or code of the authorized employee or authorized agent conducting the barter transaction, and barter offer or bartered offer, and
(g) where the retailer or wholesaler informs the individual, if they are unfamiliar with the established method or process established or approved by the retailer or wholesaler, that the barter offer or bartered offer includes the intermediate step, during the barter transaction, of the individual receiving from the retailer or wholesaler, a Bartered Value Card (BVC), or its equivalent, where once both parties accept the barter offer, or bartered offer, and or terms of barter, the ‘bartered value’ will be assigned to the BVC that he or she will receive as an ‘intermediate step’ in the barter transaction for the said coin(s), and or token(s), and or bar(s), and or bill during (s) accepted by the retailer or wholesaler and that ‘bartered value’ can be used to complete the barter transaction, partially or completely, by using the BVC with the loaded ‘bartered value’ at the checkout counter transaction, or online transaction, when checking out food or other groceries and goods at the retailer or wholesaler, and
(h) whereupon the individual must sign his or her signature, electronically using the electronic communications network device, or manually on paper, accepting the barter transaction terms, and or BTF, and or receipt, and or agreement, and or contract of the barter transaction, and
(i) whereupon or whereafter acceptance by signature of the individual to the barter transaction the retailer or wholesaler using the electronic communications network device and or card reader/writer or token reader/writer at the authorized customer service counter downloads or assigns, electronically, said ‘bartered value’ to said electronic communications network and or said BVC having a unique identifying code and where said unique code is recorded in the closed loop electronic communications network system of the retailer or wholesaler for record and identified with said bartered value and receipt, and or agreement, and or contract, and or BTF, and
(j) where the retailer or wholesaler emails a copy of the receipt, and or agreement, and to contract, and or BTF to the individual and or prints out a copy of the receipt, and or agreement, and or contract, and or BTF using the printer at the authorized customer service counter and gives said copy to the individual wherein either case the BVC having ‘bartered value’ is given to the individual, and
(k) whereafter the individual selects food or other groceries and or goods at retailer or wholesaler, in the present, or in the future, or in the future online, using the ‘bartered value’ assigned to said BVC, or its equivalent, and or said electronic communications network and where at checkout with the retailer or wholesaler ‘bartered value’ is deducted from the BVC and or said closed loop electronic communications network, and
(l) where the ‘bartered value’ on said BVC remains an accounting liability of the retailer or wholesaler until said ‘bartered value’ is depleted to zero value, which at that time the barter transaction is completed, and
(m) where BVC and its bartered value can only be used or exchanged for food or other groceries and other goods at said retailer or said wholesaler who issued the card and where said card is transacted on the retailer's or wholesaler's closed loop electronic network, and
(n) where ‘bartered value’ is numeric, or alphanumeric, or binary code representation of a ‘bartered value’ and is not a representation of, nor exchangeable for: Federal Reserve Note (FRN) currency or Central Bank Digital Currency (CBDC).

2. A method according to claim 1 wherein a security camera records a photo or video of the coins, tokens, bars, and or bills accepted for barter and or a video of said barter transaction and using said electronic communications network of said retailer or wholesaler retains said photo and or video for record off said barter transaction.

3. A method according to claim 1 wherein the Bartered Value Card (BVC) has a unique identifying number or code and is of type known as: a mag-stripe card, or a magnetic stripe card, or a magnetic stripe/micro chip card, or microchip card, or a passive transponder chip card, or a smart chip card or token, or a UPC card, or a two-dimensional matrix code card.

4. A method according to claim 1 wherein the retailer or wholesaler requires the individual to complete, in advance or in-person, by handwritten, or by electronic means, or by submission using the internet, the retailer's or wholesaler's BARTER TRANSACTION FORM (BTF), or its equivalent, where the BTF will become an electronic record or manual written record of the barter transaction of the retailer or wholesaler and the BTF will state and or record one or more of the following as deemed necessary or required by the retailer or wholesaler: name of individual, telephone number of individual, email address of individual, home address of individual, driver's license number of individual, last four digits of social security number of individual, photographic image of individual's driver's license, photographic image of bartered items, description and quantity of items intending to barter, description and quantity of items accepted for barter, present date, barter transaction number, authorized employee number or code, authorized employee name, signature of authorized employee, signature of the individual (barterer), terms of agreement, terms of contract, terms of offer, barter value amount, bartered value amount.

5. A method according to claim 4 wherein the retailer's or wholesaler's BTF, or its equivalent, includes a written statement that the barter transaction will include the individual receiving in exchange for stated bartered items a BVC with bartered value, equal to the ‘bartered value’ amount accepted in writing and which is not refundable, or exchangeable, or redeemable for any currency.

6. (canceled)

7. A method according to claim 1 where the retailer or wholesaler that sells food or other groceries includes, but not limited to, those known as: Walmart®, Sam's® Wholesale Club, Costco® Wholesale Corp., Kroger®, Fred Myer®, Harris Teeter®, Ralph's®, King Soopers®, Dillon's®, Payless®, City Market®, Jay C Food Stores®, Roundy's®, Pick'n Save®, Mariano's Smith's FoodLess Foods®, Owen's®, Copps®, Albertsons®, Safeway®, Vons®, Jewel Osco®, Shaw's®, ACME®, Tom Thumb® Randalls®, United Supermarkets®, Pavilion®s®, Haggen®, Star®, Carrs®, Ahold DelHaize USA®, Food Lion®, Stop & Shop®, Hanford®, Giant®, Publix® Super Markets®, H-E-B®, Meijer®, Meijer®, Bridge St. Market® Woodward Corner Market®, Target®, Amazon®, Whole Foods®, Walgreen's®, CVS Pharmacy® Tard®, Circle K®, Mac's Kangaroo Express®, On the Run®, Holiday&, CST®, Dollar General®, Lobular® Seven $ i Holdings®, 7 Eleven®, Stripes®, Woodland® Freshco® Price Chopper®, Shoppers®, Dollar Tree®, Family Dollar®, Aldi®, Rite Aid®, Metro®, Super C®, Food Basics®, Adonis®, Premiere Molson®, Brunet®, HyVee®, Wegmans®, Giant Eagle®, Market District®, Get Go®, Ricker's®, Southeastern Grocers®, Harvey Winn®, Seed-to-Table®, Oak Farms® Fresco®, Bi Lo®, Sunmart®, Winco Foods®, Sprouts Farmers Market®, Demoulas Super Markets®, Market Basket® Save-A-Lot®, Save-on-Foods®, Price Smart Foods®, Urban Fare®, Bulkley Valley Wholesale®, Slater Bros Markets®, Save Mart Supermarkets®, Price Chopper/Market 32® Ingles Markets®, Smart &Final®, Weis Markets®, Raley's®, BelAir®, Nob Hill Foods®, Key Food Stores®, Alex Lee®, Schnuck Markets®, Grocery Outlet®, Bodega Latina® El Super®, Fiesta®, Food City®, Super Dollar Food Center®, Buc-ee's®, Exxon Mobil®, Citgo®, BP®, Wawa®, Phillips 66®, Chevron®, Conoco®, Shell® Energy, Chevron®, Speedway®, Love's®, Sunoco®, Sheetz®, Circle K®, Kiwi Trip®, Casey's General Stores®, Pilot®, Race Track® Petroleum, Jackson Food Stores®, Fresh Market®.

8. A method according to claim 1 where the authorized employee or authorized agent inspects and evaluates the coin(s), and or token(s), and or bar(s), and or bills) using one or more of the techniques known as: visual inspection, weight inspection, terminal sliding velocity inspection, chemical analysis inspection, size inspection, magnetic test inspection, drop test analysis, acid test analysis, scratch test analysis, ping test analysis, conductivity analysis, potentiometric analysis, fire analysis, ultrasound analysis, hardness analysis, density test analysis.

9. A method according to claim 1 whereupon the using a closed loop electronic communications network device connected to an electronic card/token reader/writer, assigns ‘bartered value’, or its equivalent, to BVC, or its equivalent, having an unique identifying code, thereafter becomes the ‘bartered value’ assigned to the BVC, wherein barter transaction and bartered value can be recorded, tracked, debited each time the BVC is used to exchange ‘bartered value’ for food or other groceries or other goods.

10. A method according claim 4 where the individual can begin the process of the barter transaction, or filing a Barter Transaction Form (BTF), or its equivalent, with the retailer or wholesaler, by using: an online computer, or cellphone, or telephone that is connected to electronic communications network, or cellphone network, or telephone network to the retailer or wholesaler.

11. A method according to claim 1 wherein the coins, or tokens, or bars, and or bills are made of platinum.

12. A method according to claim 1 where the BVC having ‘bartered value’, can be transferred to or given to another individual, company, or charity for use at said retailer or wholesaler.

13. (canceled)

14. A method according to claim 1 wherein the BVC has graphics on at least one side showing at least one silver and or gold coin, and or token, and or bar, and or bill.

15. A method according to claim 4 wherein the event of loss of the BVC the retailer or wholesaler can replace the BVC with remaining ‘bartered value’ by reviewing the barter transaction records on file with the retailer or wholesaler.

16. A method according to claim 1 where the ‘bartered value’ on said BVC can be exchanged for gift card and or prepaid card, sold or bartered by the retailer or wholesaler.

17. A method according to claim 1 where the BVC can be reloaded with additional ‘bartered value’ at the authorized customer service counter by repeating the method shown in claim 1.

18. A method according to claim 1 where the BVC has a scratch off ink, on at least one side, that conceals at least one PIN number.
